(19) United States
(12) Patent Application Publication
(10) Pub. No.: US 2002/0000946 A1
(43) Pub. Date: Jan. 3, 2002

(54) Antenna feed structure

(76) Inventor: Jyrki Portin, Oulu (FI)

Correspondence Address: PERMAN & GREEN, 425 POST ROAD, FAIRFIELD, CT, 06430, US

(21) Appl. No.: 09/891,845

(22) Filed: Jun. 26, 2001

(30) Foreign Application Priority Data
Jun. 30, 2000 (FI) 20001569

(51) Int. Cl. H01Q 1/24; H01Q 9/16; H01Q 9/28

(52) U.S. Cl. 343/795; 343/820; 343/702

(57) ABSTRACT

The invention relates to an arrangement for feeding an antenna. The antenna (220) itself is symmetric. The antenna feed line (210) is also symmetric such that its conductors (211, 212) are twisted with respect to each other. In practice, half a turn is enough. The output of the stage (205) feeding the antenna is balanced. The invention facilitates a controlled radiation pattern of the antenna. The antenna feed line has a good capacitive balance, which means little interference in the operation of nearby circuits and, hence, a greater maximum transmission power. The structure is relatively simple and has low production costs.

The invention relates to an arrangement for feeding an antenna especially in small radio devices such as mobile phones.

Especially in high-frequency technology one always has to pay attention to the implementation of the transmission line between the feeding source and the circuit fed. The transmission line losses should be relatively small, and the transmission line should not significantly affect the impedance matching. The line's susceptibility to interference should be low, i.e. possible interference fields in the vicinity must not significantly degrade the signal conveyed by the line. On the other hand, the transmission line itself must not produce a field that would disturb the operation of nearby circuits. When the circuit fed is an antenna, one also has to take into account the effect of the transmission line on the radiation pattern of the antenna.

In portable radio devices the antenna usually is a monopole or a derivative thereof, the electrical length of which is most often one quarter of the wavelength that corresponds to the transmission or reception frequency. To radiate effectively the monopole requires a ground plane opposite to the feed point. In practice, the ground plane is usually provided by the equipment chassis connected to signal ground. FIGS. 1a,b show an example of such a prior-art structure with its feed arrangements. FIG. 1a shows the electrical diagram of the structure and FIG. 1b shows an example of the mechanical assembly. The structure 100 comprises an output stage 105 feeding the antenna, a transmission line 110 and an antenna 120. The output stage has a positive supply voltage V_{S}⁺ and a negative supply voltage V_{S}⁻. Thus it can feed a voltage that varies on the both sides of the signal ground potential. The transmission line comprises a feed conductor 111, ground conductor 112 connected to ground, and an insulator therebetween. In accordance with FIG. 1a the output stage feeds the antenna through the transmission line. The mechanical construction further comprises, in accordance with FIG. 1b, the equipment chassis 130, printed circuit board 140 and an antenna support 135. In this example the antenna 120 is a whip antenna that can be pushed inside the apparatus. Naturally it could be a monopole shortened with a coil or a plain helix, for example. The output stage 105 is located on the printed circuit board 140. The feed conductor 111 extends from the output stage to the antenna via a hole in the chassis plate 130. For clarity, FIG. 1b does not show the sheath-like return conductor of the feed conductor. It extends from the printed circuit board's signal ground to the chassis plate.

A disadvantage of structures like those described above is that the shape of their radiation pattern may considerably deviate from the desired shape. An ideal radiation pattern would result if there were a large perpendicular ground plane below the monopole. The shape of the equipment chassis is, however, indefinite, and its size is very limited. Unwanted radiation lobes diminish the field strength in the desired directions. This disadvantage can be alleviated by making the antenna a symmetric dipole. Then, however, the conductors of the antenna feed line, which in this case must be symmetric, may have different capacitances with respect to the equipment chassis. Even a slight difference in the capacitances causes the chassis to function as a radiator and thus alters the radiation pattern. Moreover, capacitive imbalance may result in disturbances in the operation of the apparatus in question, which limits the maximum transmission power applicable.

An object of the invention is to reduce the said disadvantages associated with the prior art. The structure according to the invention is characterized by that which is specified in the independent claim 1. Some advantageous embodiments of the invention are presented in the other claims.

The basic idea of the invention is as follows: A symmetric antenna is used with a symmetric feed line the conductors of which are twisted with respect to each other. The output of the circuit feeding the antenna is balanced. The whole structure is realized compact.

An advantage of the invention is that the antenna radiation pattern can be controlled. Another advantage of the invention is that a good capacitive balance can be achieved for the antenna feed line, which means little interference in the operation of nearby circuits and, hence, a greater maximum transmission power. A further advantage of the invention is that the structure according to the invention is relatively simple and has low production costs.

The invention is described in more detail in the following. Reference is made to the accompanying drawings in which

FIGS. 1a,b show an example of antenna feed according to the prior art,

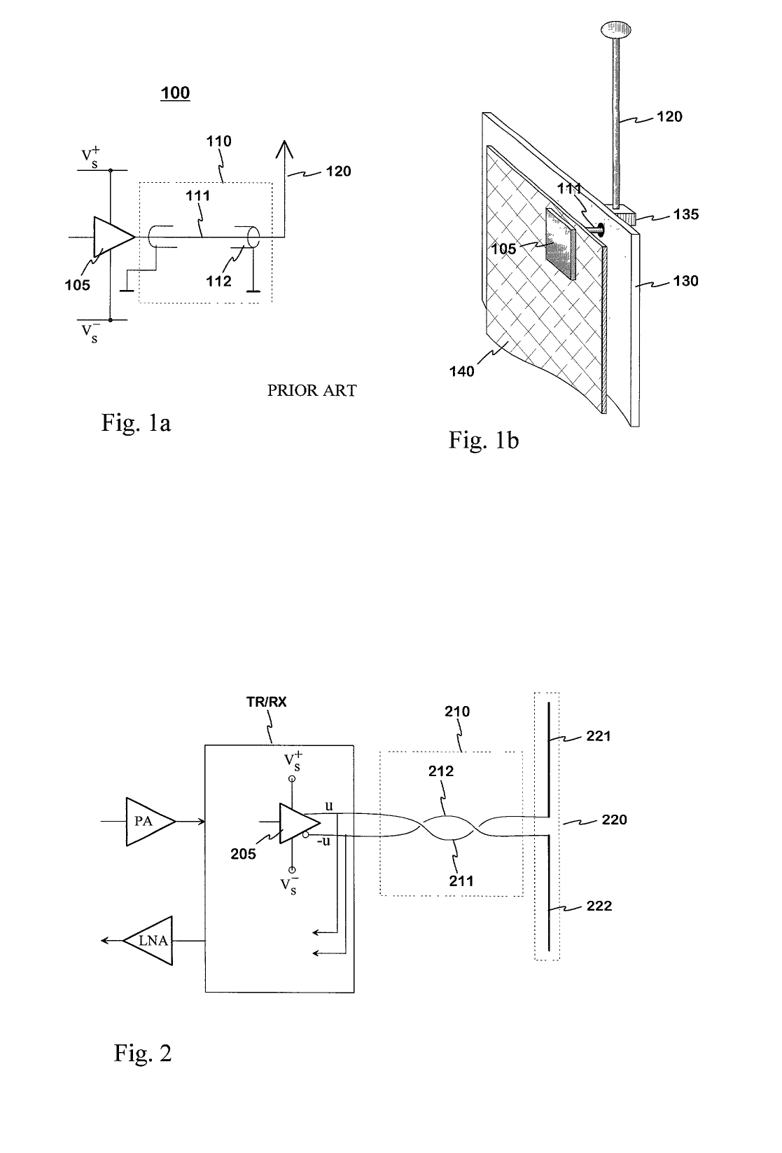

FIG. 2 illustrates the principle of the invention,

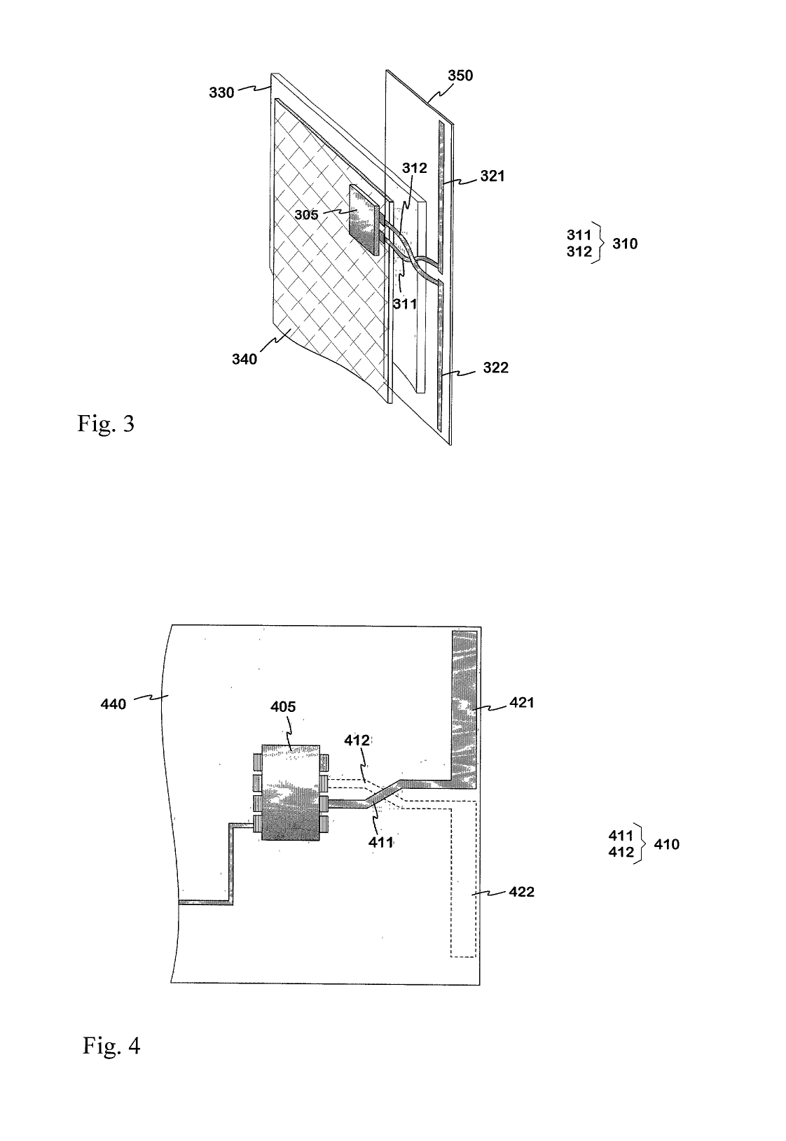

FIG. 3 shows an example of the structure according to the invention,

FIG. 4 shows another example of the structure according to the invention.

FIG. 1 was already discussed in connection with the description of the prior art.

FIG. 2 illustrates the principle of the invention with the help of a circuit diagram. The figure shows a transmitter power amplifier PA, receiver low noise amplifier LNA, transmission/reception unit TX/RX, transmission line 210 and an antenna 220. The TX/RX unit is basically a frequency-division or time-division duplexer. It only shows the output stage 205, as the rest of the elements have no relevance to the invention. The output stage has a balanced output, which is known per se. In other words the output stage has got two output contacts the states of which are always opposite, i.e. equal in absolute value but having opposite signs. In FIG. 2, the voltage of the first output contact is u, and the voltage of the second, complementary, output contact is −u. The first output contact in the output stage is connected to the first conductor 211 of the transmission line, and the second output contact is connected to the second conductor 212 of the transmission line. The transmission line 210 is symmetric, which means that its first conductor and second conductor have an equal position in the line. In addition, the first conductor and second conductor are twisted around each other in a well-known manner for one turn in this example. Twisting helps the transmission line better resist external interference and, on the other hand, produces less capacitive crosstalk in nearby circuits. The antenna 220 in this example is of the dipole type, having its feed point in the middle of the antenna. The first conductor 211 of the transmission line is connected to the first branch 221 of the dipole, and the second conductor 212 is connected to the second branch 222 of the dipole. None of the parts in the structure depicted in FIG. 2 is connected to ground. Thanks to the symmetric ground-independent structure of the antenna and the aforementioned capacitance balance of the transmission line the antenna radiation pattern is controlled.

FIG. 3 shows an example of the mechanical implementation of the structure according to the invention. It comprises an output stage 305, transmission line 310, and an antenna 321, 322. The output stage is placed on a printed circuit board 340, at the edge thereof. The conductors of the transmission line are ordinary wire conductors twisted in accordance with the invention for half a turn in this example. The antenna is a symmetric dipole. The first conductor 311 of the transmission line is connected by its one end to the antenna branch 321 which is shown uppermost in the figure and, conversely, the second conductor 312 is connected to the antenna branch 322 which is shown lower in the figure. The position of the conductors of the transmission line must remain unchanged, lest the electrical shielding of the transmission line is degraded. In the example of FIG. 3 the transmission line and antenna constitute a fixed module 350 the dielectric support material of which keeps the transmission line conductors and antenna elements in place. The module 350, which in FIG. 3 is shown only in outline, may be rigid or flexible. It is attached to or is part of the covering of the apparatus, for example. FIG. 3 further shows part of the conductive chassis 330 of the apparatus. As was mentioned above, it has no galvanic contact with the antenna circuits. The electromagnetic coupling also is weak.

FIG. 4 shows another example of the mechanical implementation of the structure according to the invention. It comprises an output stage 405, transmission line 410 and an antenna 421, 422. All these elements are placed on a printed circuit board 440. The conductors of the transmission line are now conductive strips on the surface of the printed circuit board. The first conductor 411 is shown to be located on the upper surface of the printed circuit board. It and the first antenna branch 421 are part of the same conductive strip. The second conductor 412 is shown to be located on the lower surface of the printed circuit board. It and the second antenna branch 422 are part of the same conductive strip. Looking from the power amplifier towards the antenna the end of the first conductor is on the same line with the beginning of the second conductor, and the beginning of the first conductor is on the same line with the end of the second conductor so that the conductors form an X in the middle of the transmission line. This way the conductors are twisted around each other only slightly, but even this alternation improves the electrical shielding considerably. If the printed circuit board 440 is a multi-layer board, the transmission line conductors may naturally be located in the intermediate layers of the board.

Above it was described the principle of the invention and structures according to it. The invention is not limited to these. The antenna itself may be a loop antenna or a slot antenna, for example, instead of being a conventional or “thick” dipole. The shape of the transmission line conductors and the twisting pattern may vary. The output stage may comprise two discrete components following a balanced stage. The inventional idea may be applied in different ways within the scope defined by the independent claim.

1. An arrangement for feeding an antenna of a radio apparatus, which arrangement comprises an output stage and a transmission line including a first and a second conductor, whereby
the said output stage has got a balanced output to one contact of which the first conductor is connected and to the other contact of which the second conductor is connected,
the said transmission line is symmetric and its first and second conductors are twisted with respect to each other, and
the said antenna is symmetric.

2. A structure according to claim 1, whereby the first and the second conductor are mechanically supported in order to retain their mutual position as well as their position with respect to elements of said antenna.

3. A structure according to claim 2, whereby the first conductor, the second conductor, said antenna elements and their support material constitute an integrated structural part.

4. A structure according to claim 3, whereby the said structural part is flexible.

5. A structure according to claim 2, whereby in that the first conductor, the second conductor and said antenna elements are conductive strips on the surface of a dielectric board.

6. A structure according to claim 1, whereby the first and the second conductor are twisted with respect to each other substantially half a turn.
